(19) United States
(12) Patent Application Publication
(10) Pub. No.: US 2003/0140000 A1
(43) Pub. Date: Jul. 24, 2003

(54) On-line credit assessment system and method

(76) Inventor: Eun-Woo Lee, Seoul (KR)

Correspondence Address: JACOBSON HOLMAN PLLC, 400 SEVENTH STREET N.W., SUITE 600, WASHINGTON, DC, 20004, US

(21) Appl. No.: 10/376,632

(22) Filed: Mar. 3, 2003

Related U.S. Application Data
(63) Continuation of application No. PCT/KR00/01436, filed on Dec. 12, 2000.

(30) Foreign Application Priority Data
Nov. 3, 2000 (KR) 2000/65311

(51) Int. Cl. G06F 17/60

(52) U.S. Cl. 705/38

(57) ABSTRACT

An on-line system for conducting credit assessment, including self-assessment, for all kinds of enterprises via the Internet with regard to companies having technological competitiveness. The assessment system automatically recognizes participant identification by analyzing individual client information, assesses and evaluates company credit particularly in terms of technological competitiveness, and promptly provides an assessment result to the requester via the Internet.

This is a continuation of PCT/KR00/01436 filed Dec. 12, 2000 and published in English.

### BACKGROUND OF THE INVENTION

1. Field of the Invention

The present invention is related to the field of credit assessment and, more particularly, to a system and method for providing credit assessment over a distributed computer network.

2. Description of the Related Art

Distributed computer networks best typified by the Internet have greatly impacted the world by bringing all nations together through a unitary network that provides and contains virtually unlimited information, with resulting benefit that is worldwide.

The Internet is currently utilized in many ways including commercial transactions and advertising, Internet broadcasting, email, news provision, data transmission, net surfing, stocks and money transactions, voice mail and video response systems and general information provision. Due to the rapid growth in the number of Internet users upon establishment of the network infrastructure, the Internet-based community will continue to be a growing trend, particularly among the business sectors.

Despite the significant influence the Internet has had on much of the business sector, however, consulting firms have not yet realized the potential available to them, seeing the ability to receive clients' requests and transmit credit assessments over such a network as more of a dream than a realizable reality. One of the reasons that consulting firms have not tried to use the Internet for their business is that these firms lack an appropriate model for credit assessment that may be used universally. There are many different standards of assessment and, as a result, many organizations and consultant firms still rely on their own manpower sent into the field to obtain the necessary information.

Accurate credit assessment of companies, particularly in terms of technological competitiveness, can be a critical standard to predict their future viability. For this reason, the importance of credit assessments is increasing. Credit assessment also makes companies improve their transparency, improving their credibility and establishing a base for the development of new technologies. Unfortunately, even though small and mid-sized companies realize the importance of credit assessment, if is often cost prohibitive for them to conduct such assessment, as consulting firms may charge up to tens of thousands of dollars for their advice.

Given the increased demand for qualified consulting which as arisen within the credit assessment market, more detailed checklists are needed to meet customer expectation. The development of such checklists requires a lot of time and money, again preventing a lot of small and medium-sized companies from undertaking a credit assessment. Moreover, the consulting firms do not willingly disclose their techniques and know-how acquired from the field, instead protecting the information in order to charge each client.

Even if the standards of credit assessment and checklists are the same among consulting firms, there are differences in the results obtained due to ambiguity in respondent answers and the influence of each consultant's personal judgment.

Accordingly, a need exists for a standardized system of credit assessment that is widely available and that provides rapid and accurate results.

### SUMMARY OF THE INVENTION

In view of the foregoing, one object of the present invention is to provide a credit assessment system accessed over a distributed computer network.

Another object of the present invention is to provide a dynamic on-line system for judging a company's credit status, particularly in terms of technological competitiveness, virtually instantaneously.

A further object of the present invention is to provide a system for conducting company credit assessments at low cost using a distributed computer network such as the Internet.

Yet another object of the present invention is to provide a credit assessment system accessed by email.

In accordance with this and other objects, the present invention is directed to an on-line credit assessment system. A company desiring an assessment accesses the system either on-line or via email and provides company information which is stored by the assessment system in a company database. Appropriate questions are directed to the requesting company through an Internet server, with the answers provided being stored in an answer database. Once the client company has completed the assessment data gathering process by answering all the pertinent questions, the assessment system analyzes the responses and provides, either on-screen or as a printed report, an assessment result to the client.

These and other objects of the invention, as well as many of the intended advantages thereof, will become more readily apparent when reference is made to the following description taken in conjunction with the accompanying drawings.

### BRIEF DESCRIPTION OF THE DRAWINGS

FIG. 1 illustrates the structure of the operating system for an on-line credit assessment system in accordance with the present invention; and

FIG. 2 is a flowchart summarizing the operation of the system of FIG. 1.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

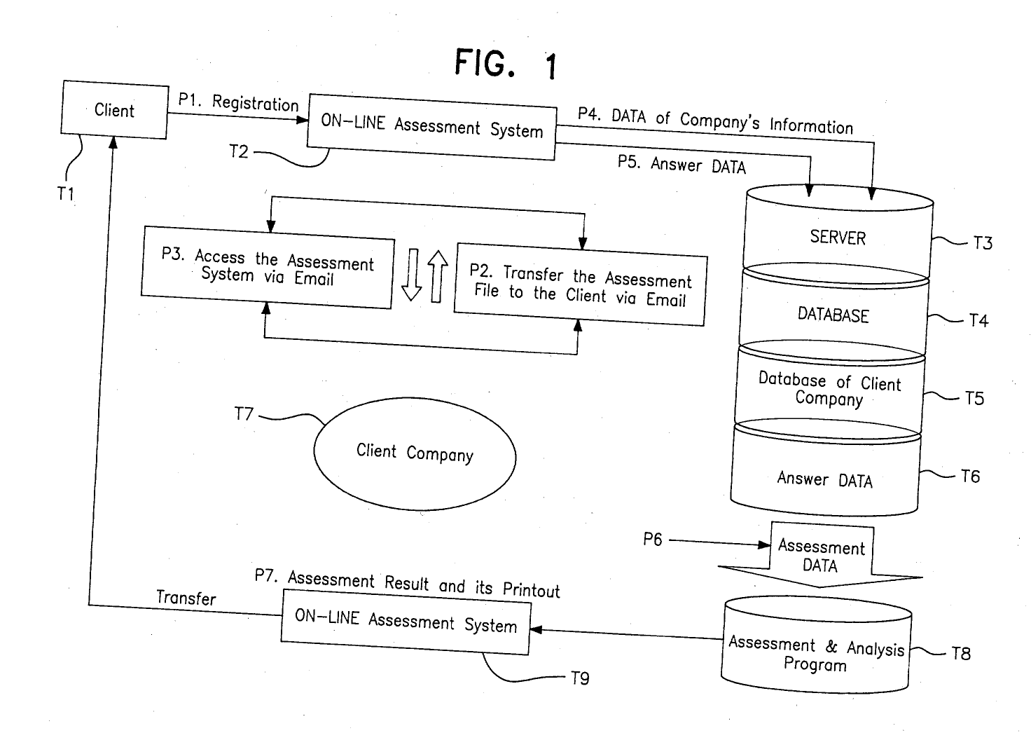

As set forth in FIG. 1, the on-line credit assessment system according to the present invention allows a client T1 to access an on-line assessment system T2 having a server T3 with database T4, client company database T5, and client answer database T6.

The client T1 accesses the on-line assessment system T2 to initiate an assessment by logging onto a web site, P1. During the P1 procedure, the client must input his or her company's information, including date of foundation, total capital, business field and sales data, in order to proceed. This company information allows the assessment system to build up a target population corresponding to each participating client in order to best meet the client's purposes.

Alternatively, a client T7 can interact with the assessment system T2, providing the necessary input information for an assessment, using email P2. When contacted by email, the assessment system T2 thereafter communicates with the client T7 by email, receiving client company information, including date of foundation, total capital, business field and sales data, and transferring the assessment file to the client via email P3.

The server T3 provides information corresponding to the client's request, receiving the client company data P4, and helping the client to choose an appropriate category for the assessment test. The database T4 contains the necessary data to conduct the assessments and builds up the client company database T5 with the client's personal company information. Once the client's information has been identified and correlated in the database T5, the system T2 transmits the questions associated with the assessment from the server T3 to the client T1, T7 via the distributed computer network, such as the Internet. The assessment questions may be transmitted to the client company either through the web site or by email.

The client T1 provides answers to the range of questions received from the server T3 through the on-line assessment system T2, with the answer data being transmitted P5 back to the server T3 and set up in the answer database T6.

When the client T1, T7 has entered the appropriate company identification information and has answered the questions pertaining to assessment, the assessment and analysis program T8 analyzes the input assessment data P6 and generates, through statistical analysis, an assessment result which is forwarded P7 to the client by the on-line assessment system T9. The assessment result may be displayed on the client's computer screen, printed as a report, or both. Clients T7 accessing the assessment system by email preferably receive the assessment report by email.

With reference to FIG. 1, while set forth twice therein, the on-line assessment system T2, T9 is the same system, but is presented with two reference numerals for clarity in explanation of the flow of the assessment process.

The on-line credit assessment system according to the present invention includes four categories of assessment data to which questions are directed: research & development (R&D) ability, ability to materialize new products, production capability, and outcome of technological competitiveness.

The category of R&D ability includes five checklists, namely technological strategy/planning, R&D department and manpower, R&D know-how, R&D fund, and R&D management and maintenance.

The category of ability materializing new products includes four checklists, namely management to develop new products, plan to develop new products, ability to develop new products, and evaluation of new product development.

The category of production capability includes three checklists, namely manufacturing ability, quality control and maintenance, and activities toward improvement.

Finally, the category of outcome of technological competitiveness includes three checklists, namely utilization of management index, management index and intellectual properties.

By collecting client information relating to these categories, the assessment and analysis program T8 can effectively calculate an assessment result score both quickly and cost effectively for virtually instantaneous transmission to the client, providing a barometer that enables a company's status to be judged instantly, particularly in view of technological competitiveness.

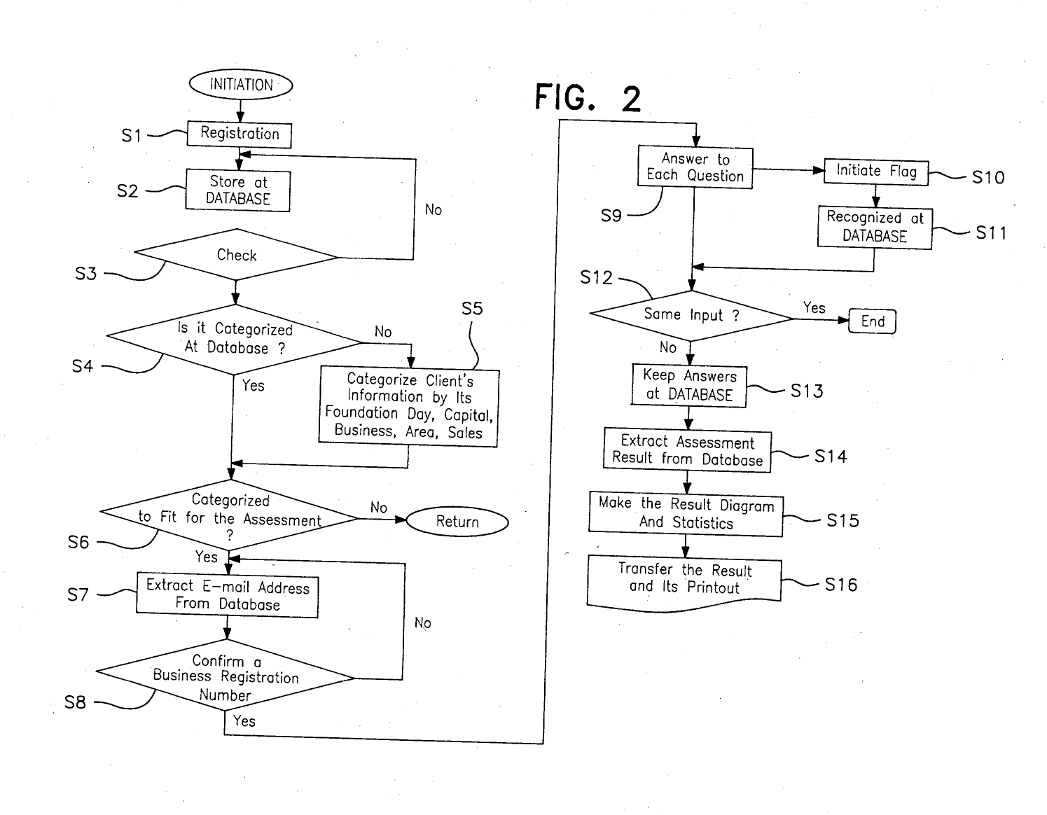

The operation of the present invention is described more particularly in FIG. 2. As shown, clients register, S1, for on-line credit assessment through email or on-line, and then the system stores S2 the client's personal information as well as those test categories requested. The system checks, S3, to verify the client's identification, and judges, S4, whether the client company is properly categorized in the company database. If not, the company is categorized, S5, by obtaining the necessary company data which may include date of foundation, capital, business area, and sales.

Companies for which identifying company data has been input to the company database are then judged to determine whether the client company is properly categorized for the assessment, S6. If not, the assessment process is terminated.

If the company is properly categorized to fit for the test, S6, the company's email address is extracted from the company database, S7, in order to confirm the company's business registration number, S8, after which further data collection in the form of answers provided to the category questions, is undertaken.

As the client responds to each question, S9, the system initiates a flag, S10, so that the client is recognized at the database, Sl, while building up the company database T5. The system checks whether the input received is the same, S12, to determine whether or not to keep the answers in the database T6. Answers are stored in the client answer database T6 only if there is no invalid input, such as the provision of the same personal information from the same participants.

If the input is not improper, the answers are stored, S13, and an assessment result is extracted from the database, S14. The data comprising the assessment result is formulated into a result diagram of charts and statistics, S15, which is transferred to the client, S16, for display and/or print-out.

While described as being an on-line Internet-based system, the assessment system according to the present invention may be used with a two-way communication system including an Internet-based information provider, local area network or any other communication network that supports email or email-type communication.

The present invention helps many business enterprises access a new type of assessment system that is affordable, introducing a new paradigm that will eventually shift traditional offline consulting onto the Internet.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. For example, the present invention may be used to conduct evaluations relating to employee qualifications for their current positions by transmitting email enabling access to the assessment system. Therefore, it is not desired to limit the invention to the specific examples disclosed or the exact construction and operation shown and described. Rather, all suitable modifications and equivalents may be resorted to, falling within the scope of the invention.

What is claimed is:

1. An on-line credit assessment system comprising:
a population database containing email addresses for a plurality of companies;
a company database containing data specific to each of said plurality of companies;
a processing system that transmits an assessment file to, and receives responses from, a requester via email; and
an assessment and analysis system that creates statistics based on the company specific data and the responses received from the requester.

2. The on-line system as set forth in claim 1, wherein the assessment file includes questions and examples.

3. A method for providing a credit assessment using an on-line credit assessment system, comprising the steps of:
registering a plurality of client companies by collecting data including date of foundation, total capital, business field and sales, for each client company over a distributed computer network;
transmitting, over the distributed computer network, an assessment file to a client company in response to information received, said assessment file including questions directed to the client company;
retrieving answers to the questions from the client company, over the distributed computer network;
analyzing the answers and preparing a credit assessment on the basis thereof; and
transmitting the credit assessment to the client company over the distributed computer network.

4. The method as set forth in claim 3, wherein the distributed computer network is the Internet and the step of registering includes accessing a web site.

5. The method as set forth in claim 3, wherein the distributed computer network is the Internet and the step of registering includes an email exchange.

6. The method as set forth in claim 3, wherein the step of transmitting includes displaying the credit assessment on screen.

7. The method as set forth in claim 3, wherein the step of transmitting includes printing the credit assessment.

8. The method as set forth in claim 3, wherein the step of retrieving answers includes checking for duplicate answers.
